(19) United States
(12) Patent Application Publication
(10) Pub. No.: US 2011/0314368 A1
(43) Pub. Date: Dec. 22, 2011

(54) Method to Generate a Software Part of a Web Page and Such Software Part

(75) Inventor: Arnauld Chevalier, Paris (FR)

(73) Assignee: Buzz Advertising Network Group, Paris (FR)

(21) Appl. No.: 12/665,872

(22) PCT Filed: Jun. 25, 2007
(86) PCT No.: PCT/IB2007/004304

§ 371 Date: Dec. 21, 2009

(51) Int. Cl. G06F 17/00; G06F 17/30

(52) U.S. Cl. 715/234

(57) ABSTRACT

The invention concerns a method to generate a software part of a web page comprising: receiving (24) from a browser downloading the web page a request for a software part to be executed by the browser, said request comprising at least an identifier of said web page, loading (26) from a storage area parameters related to said identifier, generating (28) the software part adapted to said web page, said software part comprising at least: a description of an active area of said web page, a code element able to have the browser displayed a child window when a user activates said active area, a description of said child window comprising at least a reference to a rich media content.

### FIELD OF THE INVENTION

The invention relates to the field of method to generate a software part of a web page. It relates also to a method to display a media rich syndicated content in a web page and to a syndication server as well as a computer product program.

### BACKGROUND OF THE INVENTION

Some terms that will be used extensively throughout the following text are defined hereafter.

A “web page” is the content of a file in the sense of the computer science which defines the information and the layout of this information that is displayed on a display of a workstation through a software component called a “browser”. The characteristic of a web page is to contain “links”. Often, the term “web page” designates the content of the file and the file itself.

A “link” is a part of the displayed information which, when the user activates it, generally by clicking on it, opens a new web page. Generally, a link is a text or a picture at which the address of the new web page is attached.

Nowadays, web pages are generally described by means of the HTML language which is not described here as well known of the man skilled in the art. It is sufficient to remember that this language uses “tags” to define the different elements of a web page.

The browser has two main functions: the first function is to download the file containing a requested web page from a server; the second function is to display the downloaded web page.

To increase the experience of the user navigating on the web, web pages are using more and more multimedia contents, such as video streams, animated pictures, music, etc. All this type of contents are often called “media rich content”. And the browser uses some special players, as plugin, to play the media rich content on the user workstation. A popular player is known as Shockwave player from the Adobe Inc. company.

The need to create attractive web page has also generated a need for web pages having the ability to execute some instructions on the user workstation. To achieve this, some scripting languages were developed. Nowadays, the most popular scripting languages are JavaScript and Java languages. By means of these languages, the developer of a web page is able to include in his/her web page a “script”, i.e. a software part, which will be executed by the browser during the web page display.

The text of script may be included inside the web page or be in an independent file and, in this case, the web page contains a link to the file containing the script.

In the first case, the designer includes a tag as follow:

<script language=“JavaScript1.2” JavaScript instructions></script>

And, in the second case, the designer includes:

<script language=“JavaScript1.2” src=“file address”></script>

However, the complexity of a web page containing media rich content and scripts, plus the increase in variety of type of display have generated a need to separate the content itself from the layout. To answer this need, the web normalization organization, called W3C, has standardized what is called now the CSS (Cascaded Style Sheet) technology.

The CSS technology has the advantage to group together all the information about the layout of the web page, such as character set, border size, etc. A second and very important advantage is that this information may be put in one or more separate files which are called by the web page. By using this technique, a CSS file may be shared by many web pages, guaranteeing a homogeneous look for the display of these different web pages.

Typically, to associate a CSS file to a web page, the designer includes in the web page the following tag:

<link rel=“stylesheet” type=“text/css” href=“address of the CSS file”>

The CSS standard, in its last versions, specifies some keywords modifying the appearance of the tag when the user interacts with this tag. For instance, the CSS standard defines the keyword “hover”. Applied to a style, it means that the related tag receives this style only when the mouse cursor rolls over the tag.

Often, designer combines this type of keywords with script languages to achieve smart effects such as a menu/sub-menu appearing and disappearing according to the movement of the mouse cursor.

Another technology used by web page designers is the server-side scripting language. This technology is used to design modifiable web pages according to some parameters or events. Often, this technology is used in combination with database technology to present, for instance, information extracted from a database according to some specific parameters defined by the user. Popular languages used on the server side are Java and PHP but many others exist.

The web is developed on a very decentralized assumption. Everyone may design and put online a site and everyone may, generally, access every site. However, in few instance, the decentralized factor may be a drawback. A typical case is the content syndication. In general terms, the content syndication consists to distribute a given content through many web pages/sites.

Typically, the content syndication is used by advertising company to dispatch their ads through many pages. For instance, a blogger is interested to obtain revenue from her site. She does not want to create a paying site as she knows that the audience of the site is strictly related to the free access, and she wants a lot of viewers of her site. Therefore, she is going to rent a small part of her page to an advertising company to put some ads. The advertising company is interested to propose ads that are in relation, by some way, to the content of her site, in order to maximize the interest of the viewers for the advertised product or service.

However, for practical reason, the advertising company cannot distribute a specific content which, often, has a short life time, to many sites and request the site owners to install the content in their pages.

The syndication companies have found a solution for text syndication by using the capability of a web page to have its content separated in many files.

Therefore, at the place where the syndicated content must be displayed, the site owner includes only a link directing to some pages of the syndication site. Typically, the link contains some information about the page in which it is included. When the page is downloaded, the syndication site is informed to send a specific content to the browser and the page is displayed with the syndicated content.

However, the technology used by syndication companies is not performing very well with media rich content. The drawbacks are twofold:
Media rich content often needs a large frame size to be displayed. For instance, a streamed video requires at least the eighth of the screen. However, the site owner does not want that this type of content, which is typically ads, is displayed in place of his/her own content.
The user who downloads and reads a page is interested primarily by the page content, not by ads. Therefore, he expects the less intrusive than possible syndicated content and that this content will display in full only on request. However, the technologies used nowadays for media rich content are very intrusive and often generates from the readers a feeling of reject which is not welcomed.

### SUMMARY OF THE INVENTION

Therefore, there is a need for a method able to display media rich syndicated content in a friendly way for the web page owner as well as for the web page viewer whilst maintaining the advantage of the content syndication, i.e. the centralization of the syndicated content.

To better address one or more concerns, in a first aspect of the invention a method to generate a software part of a web page comprises:
receiving from a browser downloading the web page a request for a software part to be executed by the browser, request comprising at least an identifier of web page,
loading from a storage area parameters related to said identifier,
generating the software part adapted to said web page, software part comprising at least:
   a description of an active area of web page,
   a code element able to have the browser displayed a child window when a user activates the active area,
   a description of the child window comprising at least a reference to a rich media content.

In particular embodiments:
a software part comprises at least two software files, a first software file containing a script to be executed by browser and a second software file containing style elements of active area and child window;
parameters are related to at least the layout of said active area; or
at least one parameter is related to the layout of said child window.

In a second aspect of the invention a method to display a media rich syndicated content in a web page comprises:
including in the web page a request to download a software part, request containing at least an identifier of web page and a destination address to a syndication server,
sending request to syndication server by a browser preparing to display said web page,
generating on syndication server software part based on identifier, software part comprising:
   a description of an active area of web page,
   a code element able to have the browser displayed a child window when a user activates active area,
   a description of child window comprising at least a reference to the rich media syndicated content.

In a third aspect of the invention a syndication server comprises:
storage means adapted to store at least parameters in relation with at least an identifier of a web page and media rich syndicated content,
interface means connected to internet and adapted to receive request from a browser and to send file to said browser,
generation means, connected to said interface means and said storage means, adapted to generate a software part based on said identifier, said software part comprising:
   a description of an active area of said web page,
   a code element able to have a browser displayed a child window when a user activates said active area,
   a description of said child window comprising at least a reference to the rich media syndicated content,

wherein said generation means are triggered by said interface means at reception of a request sent by the browser for the software part to be executed by the browser, said request comprising at least an identifier of said web page.

In another aspect of the invention a computer program product comprises computer readable instructions that, when executed by a processor, cause the computer to perform the steps of the preceding methods.

In another aspect of the invention a computer program product comprises computer readable instructions that, when executed by a processor, cause the computer to perform the steps of a method for
describing an active area of a web page,
having a browser displayed a child window when a user activates said active area,
describing said child window comprising at least a reference to rich media syndicated content.

These and other aspects of the invention will be apparent from and elucidated with reference to the embodiment described hereafter where:

FIG. 1 is a schematic view of internet network with workstations and servers;

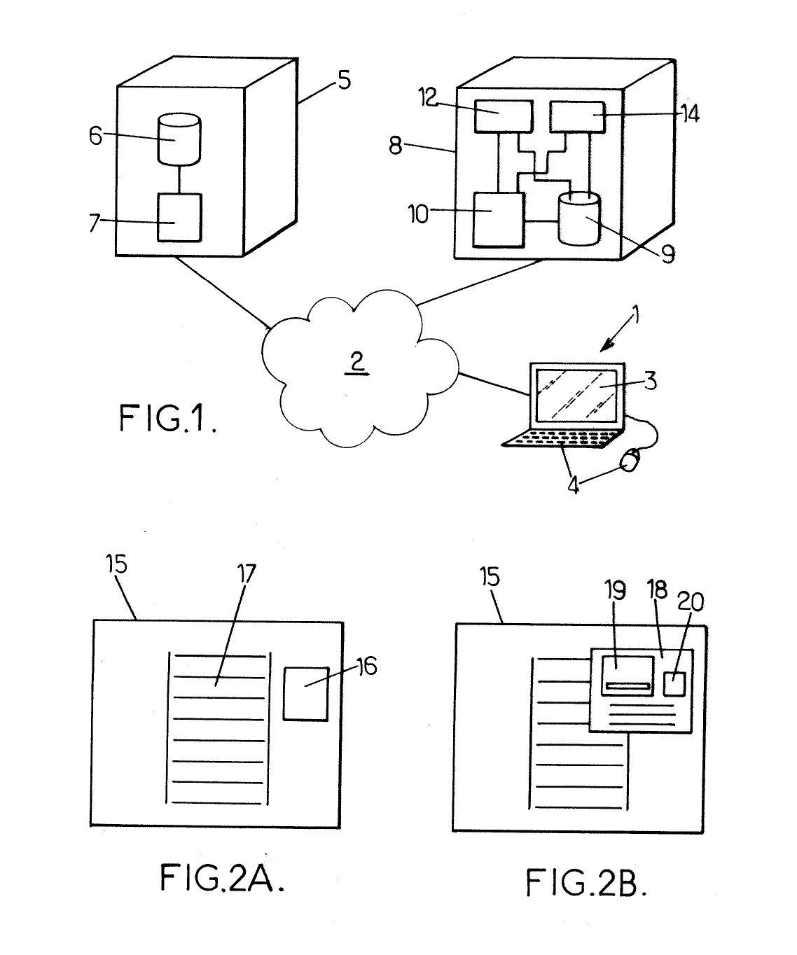

FIG. 2A is a schematic view of a web page according to an embodiment of the invention;

FIG. 2B is a schematic view of the web page of FIG. 2B with an activated child window; and

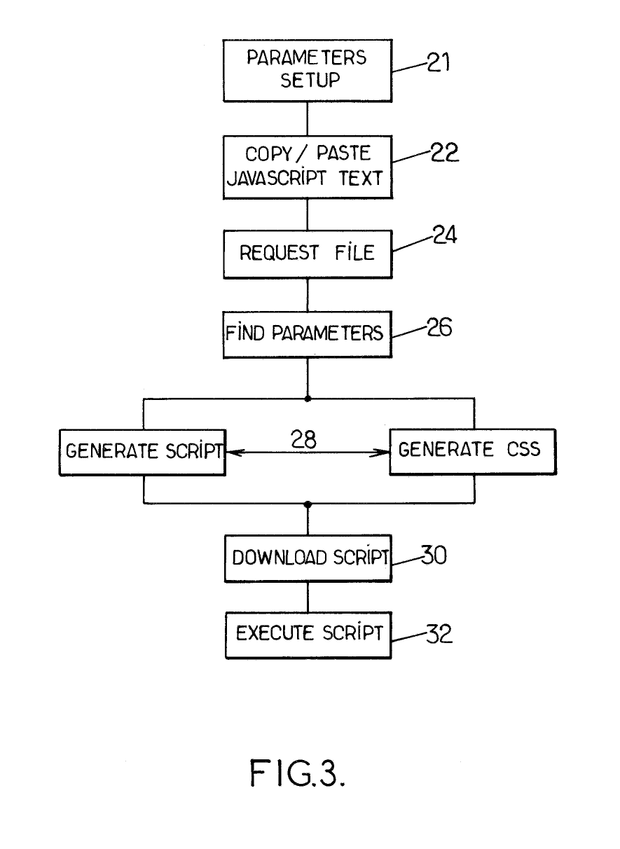

FIG. 3 is a flowchart of a method according to an embodiment of the invention.

In reference to FIG. 1, a workstation 1 is connected to Internet 2. The workstation is a standard computer well known from the man skilled in the art. It comprises at least a display 3, for instance a CRT or a LCD, and user input means 4, such as a keyboard and a mouse.

A browser is running on the workstation 1. Typically, the browser may be Internet Explorer, a product of Microsoft Corp., or Mozilla Firefox, a product of the Mozilla Foundation. It is able to execute scripts written in JavaScript as well as media rich contents in Shockwave format through a plug-in developed by Adobe Corp.

A web server 5 is connected to Internet too. It comprises storage means 6 to store web page files and interface means 7 connected to Internet and adapted to receive request from a browser and to send file to the browser. Typically, the interface means is a web software to dispatch the web pages on request, such as Apache from the Apache Foundation, Internet Server from Microsoft Inc. or others.

A syndication server 8 is connected to Internet and comprises storage means 9 to store syndicated contents and, specifically, media rich contents. It comprises also interface means 10 as the web server 5. It further comprises generation means 12, connected to the interface means 10 and the storage means 9, adapted to generate software.

It also comprises parameter setup means 14.

An embodiment of a method to display media rich syndicated content is now explained through an example.

Firstly, an exemplary web page 15 is shown FIG. 2A as displayed when the viewer is not particularly interested in the syndicated content. The syndicated content appears in a small frame 16. Typically, the frame 16 is similar to the frame used by text syndicated contents and is not particularly intrusive. In the particular example, the frame is placed on a right-side column and the main content of the web page is displayed in a large central column 17.

FIG. 2B shows the same web page as displayed when the viewer has rolled the mouse cursor over the frame 16. The frame 16 is transformed in a large frame 18 of, for instance, a quarter of the screen size. The large frame 18 contains a player 19, for instance a Shockwave player, to display a media rich content and other information 20 such as logo, picture, text, etc. The frame 18 may include also some links to, for instance, the web site of the owner of the syndicated content. To differentiate the two frames and show the dynamic aspect, the small frame 16 is called an active area and the large frame 18 a child window.

The method to achieve such result is explained in reference to FIG. 3.

In step 21, the owner of the web page stored into the server 5 registers a web page at the syndication server 8. During registration, the web page owner defines some parameters in relation with the layout of the web page and the position and size of the syndicated content inside the web page.

The parameters are stored in the storage means 9 and related to an identifier id of the web page.

At the end of the registration step, the owner receives a small text to include in the web page, at step 22.

The small text is typically a JavaScript tag containing the identifier id.

For instance, the text is

<script src=“syndication_site_address/ad.php?id=123456” type=“text/javascript”></script>

It means that the browser, when reading the web page to display it, needs to download a file, at step 24, at the address:

syndication_site_address/ad.php?id=123456

As the man skilled in the art understands it, this address is those of a file written in PHP, i.e. a file to dynamically generate a file by using the PHP scripting language on the server. And this address contains a parameter, i.e. the id parameter, to pass to the PHP script.

Therefore, through the identifier id, the script knows the page for which the file must be generated.

At step 26, the PHP script uses the identifier id to find the parameters related to the web page, parameters stored in the storage means 9 at step 20.

At step 28, the PHP script uses the found parameters to generate a personalized script file. At the same time, it generates a CSS file and eventually, a XML parameter file for the Shockwave player. At step 30, the script file is downloaded to the workstation.

At step 32, the browser starts the execution of the script to complete the analysis and display of the web page.

The script contains two main functions to be executed sequentially.

The first function generates a request to download the CSS file generated at step 28 by the PHP script on the syndication server 8.

For instance, the JavaScript function contains the following instructions:

var sc=document.createElement(‘link’); definition of an element of type “link”

sc.type=‘text/css’; this element contains CSS formatted text

sc.rel=‘stylesheet’; it is a CSS stylesheet

sc.href=‘CSS_file_address’, it is referenced at this address

document.getElementsByTagName(‘head’)[0].appendChild(sc), after downloading, the CSS file must be appended in the web page in the “header” part.

The second function generates the HTML code to define the frames 12 and 16 of FIGS. 3A, 3B. In more general terms, the second function generates the HTML code for an active area 16 and for a child window 18 as well as the activation code of the active area 16, i.e. the code executed to display the child window 18 when the viewer rolls the mouse cursor on the active area 16.

Typically, the second function generates the details of a named <div> tag. In HTML, basically, a <div> tag defines an area in the page so that the content includes inside the <div></div> tags appears inside the area. The name of the <div> tag is the same name used in the CSS file to apply the formats of the CSS file to this <div> tag.

Inside the generated HTML code, all type of contents may be included. In particular, media rich contents are included as objects of Shockwave type, for instance.

To minimize the size of the downloaded script file, the content is defined, as much as possible, as links to a content stored in the syndication server or in another related server.

The dynamic appearance of the child window 18 of FIG. 3B is generated by a combination of styles with the keyword “hover” in the CSS file and of JavaScript functions as in the exemplary dynamic menu/submenu. It means that the child window is generated but not shown from the beginning of the web page display and that the activation modifies the attributes from “invisible” to “visible”.

While the invention has been illustrated and described in details in the drawings and foregoing description, such illustration and description are to be considered illustrative or exemplary and not restrictive; the invention is not limited to the disclosed embodiment.

For instance, the embodiment is described for one dynamic frame. However, the man skilled in the art understands that the teaching applies also for two, three or more dynamic frames in the web page.

Similarly, he will have no difficulty to modify the different generated files to suit his need and, for instance, to merge the CSS file into the JavaScript file or to use other languages, such as Java, to implement the same functionalities.

In the described embodiment, the child window is defined through the “hover” keyword and JavaScript function. However, the child window may be another type of window such as a “pop-up” window.

The described method has the advantage to keep the centralization of the syndicated contents as all content files are stored in the syndication server or a related server. It has the advantage to be very easy to implement by the web page designer as he needs only to copy and paste a line of code into the web page. It has the advantage to be unobtrusive for the designer and the viewer of the web page as the layout of the active area may have the same size than the layout of nowadays text syndicated content. And at the same time, when requested by the viewer, the media rich content may be viewed at a normal size.

Other variations to the disclosed embodiments can be understood and effected by those skilled on the art in practicing the claimed invention, from a study of the drawings, the disclosure and the appended claims. In the claims, the word “comprising” does not exclude other elements and the indefinite article “a” or “an” does not exclude a plurality.

1. Method to generate a software part of a web page comprising:
receiving from a browser downloading the web page a request for a software part to be executed by the browser, said request comprising at least an identifier of said web page,
loading from a storage area, parameters related to said identifier,
generating the software part adapted to said web page, said software part comprising at least:
a description of an active area of said web page,
a code element able to have the browser display a child window when a user activates said active area,
a description of said child window comprising at least a reference to a rich media content.

2. Method according to claim 1, wherein said software part comprises at least two software files, a first software file containing a script to be executed by said browser and a second software file containing style elements of said active area and said child window.

3. Method according to claim 1, wherein said parameters are related to at least the layout of said active area.

4. Method according to claim 3, wherein at least one parameter of said parameters is related to the layout of said child window.

5. Method to display a media rich syndicated content in a web page comprising:
including in the web page a request to download a software part, said request containing at least an identifier of said web page and a destination address to a syndication server,
sending said request to said syndication server by a browser preparing to display said web page,
generating on said syndication server said software part based on said identifier, said software part comprising:
a description of an active area of said web page,
code element able to have the browser display a child window when a user activates said active area,
a description of said child window comprising at least a reference to the rich media syndicated content.

6. A syndication server comprising:
storage means adapted to store at least parameters in relation with at least an identifier of a web page and media rich syndicated content,
interface means connected to internet and adapted to receive request from a browser and to send file to said browser,
generation means, connected to said interface means and said storage means, adapted to generate a software part based on said identifier, said software part comprising:
a description of an active area of said web page,
a code element able to have a browser display a child window when a user activates said active area,
a description of said child window comprising at least a reference to the rich media syndicated content,
wherein said generation means are triggered by said interface means at reception of a request sent by the browser for the software part to be executed by the browser, said request comprising at least an identifier of said web page.

7. Syndication server according to claim 6, further comprising parameter setup means adapted to allow a designer of said web page to modify said parameters.

8. Syndication server according to claim 6, wherein said parameters comprise parameters defining the layout of the active area and/or the child window.

9. Computer program product comprising computer readable instructions that, when executed by a processor, cause the computer to perform the steps of a method according to claim 1.

10. Computer program product comprising computer readable instructions that, when executed by a processor, cause the computer to perform the steps of a method for
describing an active area of a web page,
having a browser displayed a child window when a user activates said active area,
describing said child window comprising at least a reference to the rich media syndicated content.
